(19) United States
(12) Patent Application Publication
(10) Pub. No.: US 2007/0043762 A1
(43) Pub. Date: Feb. 22, 2007

(54) Object-oriented system and method for transforming and loading wafer test data

(75) Inventor: Navin Tandon, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/205,979

(22) Filed: Aug. 17, 2005

(51) Int. Cl. G06F 17/00

(52) U.S. Cl. 707/103 R

(57) ABSTRACT

In one embodiment, a object-oriented method for transforming and loading wafer test data includes receiving a first data set having a first data format from testing of a semiconductor wafer, determining a decoupling object based on the first data format, transforming the first data format to a second data format based on the decoupling object to create a second data set, and transforming the second data format to a third data format to create a third data set.

### TECHNICAL FIELD OF THE INVENTION

This invention relates in general to the testing of electronic components and, more particularly, to an object-oriented system and method for transforming and loading wafer test data.

### BACKGROUND OF THE INVENTION

To promote emerging semiconductor technologies, various forms of wafer electrical characterization data are collected for analysis. These data for “future-roadmap” technologies are collected on new tools, specialized vendor tools, or through hardware enhancements to existing tools. These raw data sets may all have unique formats, which adds to the challenge of being able to analyze these data for process improvement and yield analysis by engineers using familiar data analysis software tools. Usually, there is a need to transform these test data sets to achieve a consistent format, and load the data to standardized and existing schemas of test databases, with the goal of being able to use current data analysis tools or programs. Due to each data collection framework being unique, current software systems to transform and load the respective data sets tend to be custom solutions with no or very little software design or code reuse among them.

### SUMMARY OF THE INVENTION

In one embodiment, a object-oriented method for transforming and loading wafer test data includes receiving a first data set having a first data format from testing of a semiconductor wafer, determining a decoupling object based on the first data format, transforming the first data format to a second data format based on the decoupling object to create a second data set, and transforming the second data format to a third data format to create a third data set.

Depending on the specific features implemented, particular embodiments of the present invention may exhibit some, none or all of the following technical advantages. Various embodiments present a reusable, modifiable, and scalable design framework and its reference implementation to transform and load to a test database any type of wafer test data, especially those collected to support yield ramps on emerging semiconductor technologies. Such a design framework may be a mesh and extension of many different techniques related to designing and developing “reusable” object-oriented software, such as abstraction, encapsulation, inheritance, polymorphism, and design patterns. The design framework may be presented in Unified Modeling Language (UML) notation. One solution may include developing the software system as a collection of software blocks (called classes or objects) that are designed to be reusable for other similar projects.

Other technical advantages are readily apparent to one skilled in the art from the following figures, descriptions, and claims.

### BRIEF DESCRIPTION OF THE DRAWINGS

For a more complete understanding of the invention and the advantages thereof, reference is now made to the following description, taken in conjunction with the accompanying drawings, wherein like reference numerals represent like parts, in which:

FIG. 1 is a block diagram of a system for transforming and loading wafer test data according to one embodiment of the invention;

FIG. 2 a block diagram using unified modeling language (UML) graphical notation of a transform and load tool according to one embodiment of the invention; and

FIG. 3 is a flowchart of a method for transforming and loading wafer test data according to one embodiment of the invention.

### DETAILED DESCRIPTION OF EXAMPLE EMBODIMENTS OF THE INVENTION

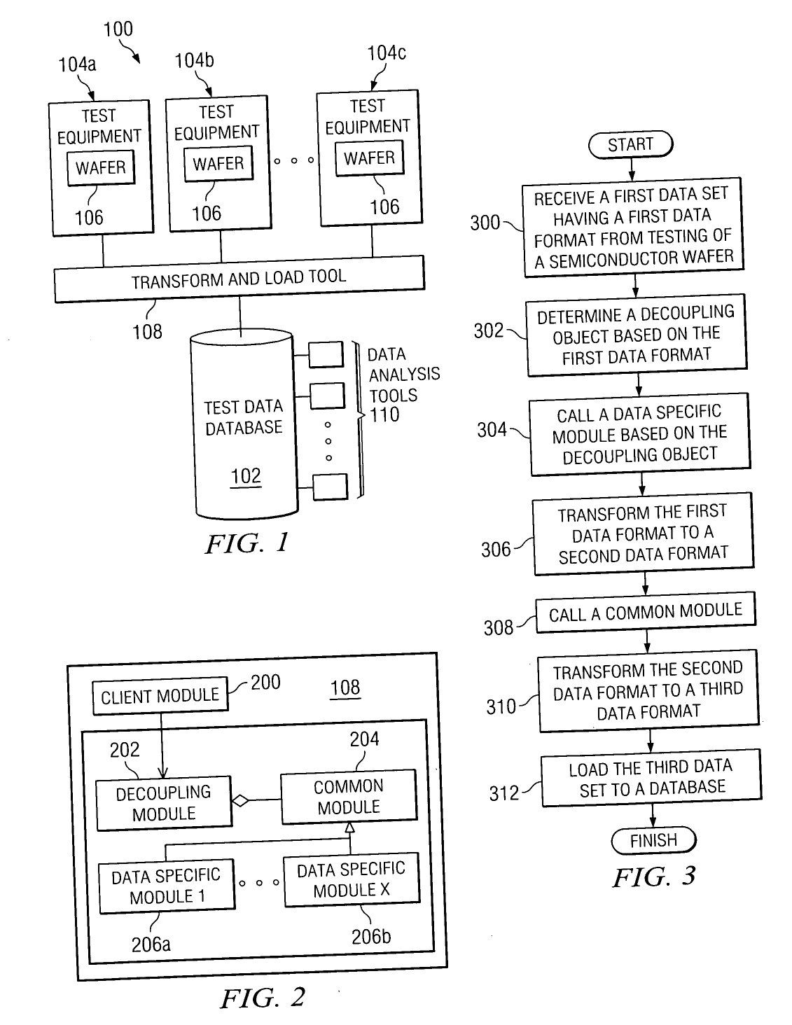

FIG. 1 is a block diagram of a system 100 for transforming and loading wafer test data according to one embodiment of the invention. In the illustrated embodiment, system 100 includes test equipment 104 testing wafers 106, a transform and load tool 108, and one or more data analysis tools 110 coupled to a test data database 102.

Test equipment 104 may be any suitable combination of hardware and/or software operable to perform any suitable number or types of tests on wafers 106, such as electrical characterization test to collect test data for analysis. Testing equipment 104 may be new testing devices, specialized vendor testing tools, or may represent hardware and/or software enhancements to existing testing devices. Merely as examples, test equipment 104a may represent scatterometers, test equipment 104b may represent RF testers, and test equipment 104c may represent special electrical characterization testers. Test equipment 104 is operable to obtain raw test data from the testing of wafers 106, which represent any suitable semiconductor wafers formed from any suitable material and having any suitable semiconductor devices or portions of semiconductor devices formed therein. Because of the different types of test equipment 104, the raw test data obtained from these testers may have different data formats, which adds to the challenge of being able to analyze these raw data sets using common data analysis tools 110, for example. Thus, there may be a need to transform these raw data sets to a common test data format.

According to the teachings of one embodiment of the invention, system 100 utilizes transform and load tool 108 to perform the transformation and loading of raw test data. Transform and load tool 108 represents a reusable, modifiable, and scalable design framework for any type of wafer test data. Tool 108 may include both reusable components common to any data format, as well as custom system components that are specific to a raw data format. Some functionality of transform and load tool 108 is described in detail below in conjunction with FIGS. 2 and 3. Generally, transform and load tool 108 may be any suitable computer program or programs written in any suitable computer language that is operable to transform raw test data received from test equipment 104 to one or more different data formats and load these other data formats to test data database 102. In one embodiment, transform and load tool 108 is logic encoded in a suitable memory. However, in other embodiments, transform and load tool 108 may be implemented through application specific integrated circuits, field programmable gate arrays, digital signal processors, or other suitable specific or general purpose processors.

Test data database 102 may include any suitable volatile or non-volatile memory. Test data database 102 may comprise random access memory, read only memory, CD-Rom, removable memory devices, or any other suitable device that allows storage and/or retrieval of data. Test data database 102 may be in any suitable physical location with respect to transform and load tool 108 and may be coupled to transform and load tool 108 and data analysis tools 110 in any suitable manner.

Data analysis tools 110 may be any suitable combination of hardware and/or software that is operable to analyze data stored in test data database 102 that is related to the testing of wafers 106. For example, data analysis tools 110 may be those provided by companies such as Spot Fire, Inc., JMP, and SAS, and may access test data database 102 with the goal of semiconductor process improvement and product yield enhancement.

FIG. 2 is a block diagram using unified modeling language (“UML”) graphical notation of transform and load tool 108 according to one embodiment of the invention.

One reason UML graphical notation is utilized in FIG. 2 is because, in one embodiment, transform and load tool 108 uses object-oriented software techniques. For example, some embodiments of the invention are a mesh of object-oriented software concepts, such as decomposition into classes, abstraction, encapsulation, inheritance, polymorphism, and patterns. In the illustrated embodiment, transform and load tool 108 includes a client module 200, a decoupling module 202, a common module 204, and data specific modules 206. The present invention contemplates transform and load tool 108 having more, fewer, or different modules than those illustrated in FIG. 2. In addition, each of the modules represented in FIG. 2 may be any suitable software modules written in any suitable computer language, and may also be referred to herein as classes or objects.

Client module 200 functions as a sequencer having the general responsibility of coordinating the data transformation and loading process. For example, client module 200 calls the various modules of transform and load tool 108 by sending them messages. In one embodiment, client module 200 is operable to determine a decoupling object based on the raw test data received from test equipment 104. Client module 200 creates an instance, or object of data specific module 206a by using a constructor method associated therewith, and uses the constructed instance of data specific module 206a as an argument for the constructor method of decoupling module 202 to create an object of decoupling module 202.

Decoupling module 202 is a context class that is used as an intermediary to reduce dependency in the design of transform and load tool 108 between client module 200 and common module 204/data specific modules 206. In one embodiment, decoupling module 202 includes a constructor method that can accept as its argument either an object of common module 204 or any subclass of common module 204 (i.e., data specific modules 206). Another method of decoupling module 202 calls a method of the passed-in object of the common module 204 or data specific module 206 so that it may perform its function of converting from raw first data format to consistent second data format. Other suitable methods and/or functionality of decoupling module 202 are contemplated by the present invention.

Common module 204 includes common-factored functionality of transform and load tool 108. For example, if all test data to be loaded into test data database 102 is to be transformed from one specific format to another specific format, then common module 204 may encapsulate and provide common reusable methods to make that transformation and also to load the data into test data database 102. For example, if all raw test data is to be transformed into a consistent ASCII format and then the ASCII format transformed into binary format before being loaded, then common module 204 would be operable to make that transformation from ASCII to binary and then load the binary data into test data database 102.

Common module 204 may be referred to as a superclass having as subclasses data specific modules 206a and 206b. In one embodiment, common module 204 provides an abstract definition (not implementation) of a data transformation method that is actually implemented by data specific module 206a and data specific module 206b, respectively, depending on the specific raw data format. The present invention contemplates other suitable methods and/or functionality associated with common module 204.

Data specific modules 206a, 206b are subclasses of common module 204 that function to transform raw test data from test equipment 104 to a common data format that is used by common module 204. For example, data specific module 206a may be used, when called, to transform raw test data that is in one specific type of data format (e.g., XML) to another type of consistent data format (e.g., ASCII), while data specific module 206b may be used to transform raw test data that is in a different data format (e.g., tables) to ASCII. This encapsulation technique of object-oriented software design localizes any anticipated future modifications to transform and load tool 108. Any suitable transformation techniques may be utilized within the teachings of the present invention.

FIG. 3 is a flowchart illustrating an example method of transforming and loading wafer test data according to one embodiment of the invention. The method outlined in FIG. 3 illustrates merely some of the functionality of transform and load tool 108.

The method begins at step 300 where a first data set having a first data format is received from test equipment 104 that is testing wafer 106. As described above, this first data set is the raw test data from test equipment 104. A decoupling object is determined based on this first data format at step 302. This decoupling object is determined by client module 200.

Data specific module 206 is called by decoupling module 202 based on the decoupling object at step 304. The method of data specific module 206 that is called transforms the first data format to a second data format, as indicated by step 306. This may be, for example, transforming an XML raw data format to a suitable/consistent ASCII format. Then common module 204 is called, at step 308, by client module 200 in order to transform this second data format to a third data format, as indicated by step 310. This may include, for example, transforming the consistent ASCII format to a binary data format that is suitable for database loading. The third data set may then be loaded to test data database 102, as indicated by step 312. For example, the binary test data may be stored in test data database 102 so that it may be used by data analysis tools 110 for any suitable yield analysis.

Thus, the design of transform and load tool 108 represents a pattern-type framework that is easily expandable to any future implementation for other specific data formats. For example, assume a future data format referred to as “XYZ” needs transformation and loading into test data database 102. According to the teachings of the present invention, all that is needed is to create a new data specific module 206 that would be a subclass of common module 204. Due to the subclassing, the new data specific module 206 automatically inherits and reuses the methods of common module 204. The new data specific module 206 only has to provide its own transformation method which takes the specific raw data format (XYZ) and convert it to the common data format contemplated by common module 204. In one embodiment, this pattern-type framework may support a generic client module 200 that chooses the specific data format based on a run-time switch. Or, only a minor change may be needed to create the new data specific module 206 using another data specific module 206 as a starting point.

Although embodiments of the invention and their advantages are described in detail, a person skilled in the art could make various alterations, additions, and omissions without departing from the spirit and scope of the present invention, as defined by the appended claims.

What is claimed is:

1. An object-oriented method for transforming and loading wafer test data, comprising:
receiving a first data set from testing of a semiconductor wafer, the first data set having a first data format;
determining a decoupling object based on the first data format;
transforming the first data format to a second data format based on the decoupling object to create a second data set; and
transforming the second data format to a third data format to create a third data set.

2. The method of claim 1, further comprising storing the third data set in a database.

3. The method of claim 1, wherein the second data format is an ASCII data format.

4. The method of claim 1, wherein the third data format is a binary data format.

5. The method of claim 1, wherein transforming the first data format to the second data format based on the decoupling object comprises calling a data specific module to perform the transformation.

6. The method of claim 1, wherein transforming the second data format to the third data format comprises calling a common module to perform the transformation.

7. The method of claim 1, further comprising deleting the second data set after transformation to the third data set.

8. Logic encoded in a computer readable medium and, when executed by a processor, operable to:
receive a first data set from testing of a semiconductor wafer, the first data set having a first data format;
determine a decoupling object based on the first data format;
transform the first data format to a second data format based on the decoupling object to create a second data set; and
transform the second data format to a third data format to create a third data set.

9. The logic of claim 8, further operable to store the third data set in a database.

10. The logic of claim 8, wherein the second data format is an ASCII data format.

11. The logic of claim 8, wherein the third data format is a binary data format.

12. The logic of claim 8, further operable to call a data specific module to perform the transformation from the first data format to the second data format.

13. The logic of claim 8, further operable to call a common module to perform the transformation from the second data format to the third data format.

14. The logic of claim 8, further operable to delete the second data set after transformation to the third data set.

15. An object-oriented system for transforming and loading wafer test data, comprising:
a testing device operable to obtain a first data set from testing of a semiconductor wafer, the raw test data having a first data format;
a client module operable to determine a decoupling object based on the first data format;
a data specific module operable to transform the first data format to a second data format and create a second data set based on the decoupling object; and
a common module operable to transform the second data format to a third data format to create a third data set.

16. The system of claim 15, further comprising a database operable to store the third data set.

17. The system of claim 15, wherein the second data format is an ASCII data format.

18. The system of claim 15, wherein the third data format is a binary data format.

19. The system of claim 15, further comprising a decoupling module operable to call the data specific module to perform the transformation from the first data format to the second data format.

20. The system of claim 15, wherein the client module is operable to call the common module to perform the transformation from the second data format to the third data format.
